(19) United States
(12) Patent Application Publication
(10) Pub. No.: US 2025/0121288 A1
(43) Pub. Date: Apr. 17, 2025

(54) METHODS AND SYSTEMS FOR IMPLEMENTING AND UTILIZING INTERACTIVE NEURAL ENGINES IN INTERACTIVE PLATFORMS

(71) Applicant: Michael Callahan, San Francisco, CA (US)

(72) Inventor: Michael Callahan, San Francisco, CA (US)

(21) Appl. No.: 18/380,957

(22) Filed: Oct. 17, 2023

(51) Int. Cl. A63F 13/67; A63F 13/655

(52) U.S. Cl. CPC A63F 13/67; A63F 13/655

(57) ABSTRACT

Methods and systems are provided for implementing and utilizing interactive neural game engines in interactive gaming platforms. In a gaming platform that includes a user device that includes or is coupled to a display, and an interactive neural game engine that includes one or more circuits, input data and interaction data may be processed using artificial intelligence (AI). Based on the processing of the input data and the interaction data, output data for a game playable via the user device may be generated using the artificial intelligence (AI), for use during playing of the game via the user device. The output data includes data relating to one or both of rendering of a game environment associated with the game and/or one or more game entities associated with the game, and rendering of interactions with the game environment and/or the one or more game entities.

### TECHNICAL FIELD

Aspects of the present disclosure relate to electronic gaming. More specifically, certain implementations of the present disclosure relate to methods and systems for implementing and utilizing interactive neural engines in interactive platforms.

### BACKGROUND

Conventional gaming platforms may be costly, cumbersome, and/or inefficient—e.g., they may be complex and/or time consuming. Further limitations and disadvantages of conventional and traditional approaches will become apparent to one skilled in the art, through comparison of such systems with some aspects of the present disclosure as set forth in the remainder of the present application with reference to the drawings.

### BRIEF SUMMARY

Methods and systems are provided for implementing and utilizing interactive neural engines in interactive gaming platforms, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 is a diagram illustrating communication devices for an interactive gaming platform.

FIG. 2 illustrates an interactive gaming platform.

FIG. 3 is a flow chart for an interactive gaming platform.

FIG. 4 illustrates an interactive gaming platform scene generation.

FIG. 5 illustrates an interactive gaming platform using a reality-based generated scene.

FIG. 6 illustrates a flowchart of machine learning scene generation.

FIG. 7 illustrates an example interactive neural engine used in an interactive gaming platform.

FIG. 8 illustrates a scenario utilizing an interactive neural game engine.

### DETAILED DESCRIPTION

As utilized herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry or a device is “operable” to perform a function whenever the circuitry or device comprises the necessary hardware and code (if any is necessary) to perform the function, regardless of whether performance of the function is disabled or not enabled (e.g., by a user-configurable setting, factory trim, etc.).

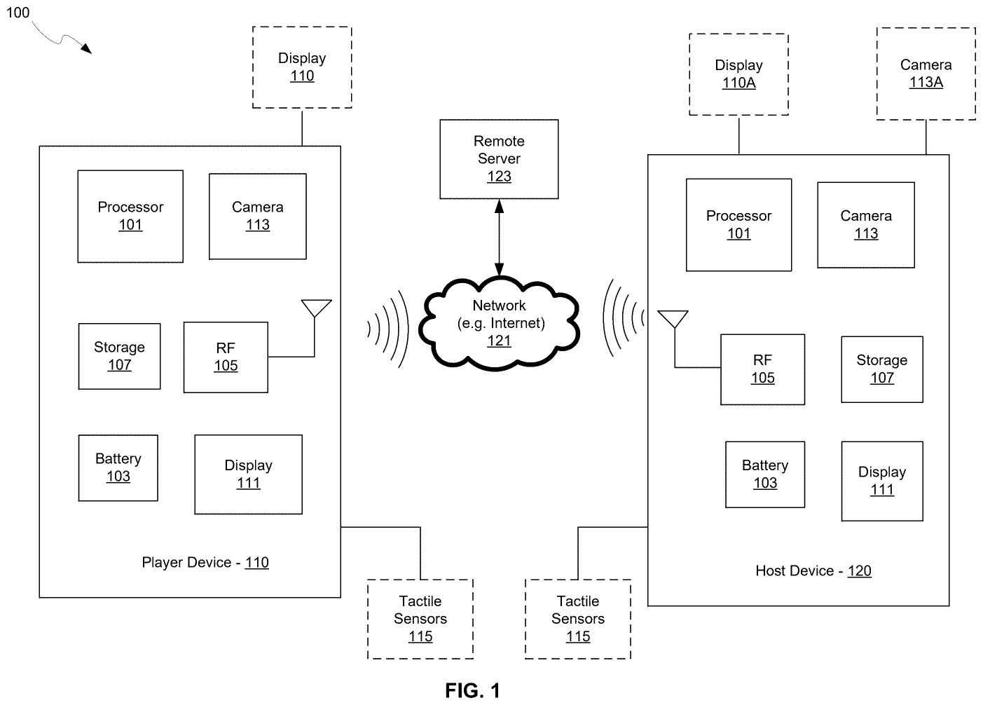

FIG. 1 is a diagram illustrating communication devices for a personal interaction game platform. Referring to FIG. 1, there is shown a personal gaming system 100 with a player device 110, a network 121, an optional remote server 123, and a host device 120. The player device 110 may comprise any device used for communication such as a cell phone, tablet, desktop computer, or laptop, for example, with computing and storage capability, although some of such capability may be performed by other devices in communication with the player device 110, while the host device may comprise a mobile device such as a cell phone, tablet, or laptop, for example, and may be coupled to optional display 111A, camera 113A, and tactile sensors 115, and/or other sensing and feedback equipment.

The player device 110 and host device 120 may each comprise a processor 101, a battery 103, a wireless radio frequency (RF) front end 105, storage 107, a display 111, and a camera 113.

The processor 101 may control the operations of the player device 110/host device 120, storing information in the storage 107, enabling communications via the RF front end 105, processing information received via a keyboard or other input mechanism, such as may be configured in the display 111, for example, and other suitable control operations for the player device 110/host device 120. The battery 103 may provide power for the player device 110/host device 120 and the storage 107 may comprise a memory device for storing information. In an example scenario, the storage 107 may store gaming functions, such as command structures for the user of the player device 110/host device 120. The storage 107 may also store photos and/or videos taken by the camera 113.

The RF front end 105 may comprise suitable circuitry for communicating wirelessly with other devices via one or more networks, such as the network 121. The RF front end 105 may therefore communicate utilizing various communications standards, such as GSM, CDMA, LTE, WiFi, Bluetooth, Zigbee, etc., and therefore may comprise one or more antennae, filters, amplifiers, mixers, and analog-to-digital converters, for example.

The camera 113 may comprise one or more imaging sensors and optics for focusing light onto the sensors, and may be operable take pictures and video through operation of the user of the player device 110/host device 120. The host device 120 may also comprise an external camera 113A, such as a small portable camera mounted on the body of the user of the host device 120, hereinafter referred to as the host, to enable a first-person view of gaming activities. In an example scenario, the camera 113A may take video that may be communicated to the player device 110 such that its user, hereinafter referred to as the player, may be presented with the environment in which the user of the host device 120 is located. Similarly, the optional displays 111A may comprise a headset display for providing optical information to the player and/or host. One or more external cameras may be affixed to other devices such as tripods, walls, airborne drones, robots, other people, and/or other stationary and mobile items. The camera information can be augmented with additional information synthesized by a computer. In an example scenario, the camera has infrared camera capabilities and captures information used to estimate the pose of the host and control the rig of a 3D character.

The tactile sensors 115 may be pressure sensitive sensors and actuators that may be operable to provide tactile feedback to the player and/or host. For example, the tactile sensors may comprise micro-electro-mechanical system (MEMS) devices that sense the motion of the player's hand to provide a motion command to the host. In addition, the host's tactile sensors may sense via pressure sensors that the host has touched an object and actuators in the player's tactile sensor may provide pressure to the player's hand in that location to provide tactile feedback. Other examples of sensors in the tactile sensors 115 may include temperature sensors, light sensors, moisture sensors, etc., where the sensing is intended to mimic as much as possible of the host's environment.

The network 121 may comprise any communication system by which the devices communicate with other devices, such as the remote server 123 and the host device 120. As such, the network 121 may comprise the Internet, a local WiFi network, one or more cellular networks, etc.

The remote server 123 may comprise a computing device or devices for assisting in gaming functions between the host device 120 and the player device 110. The remote server 123 may be optional in instances when gaming databases, commands, or functions are stored locally on the player device 110 and/or the host device 120.

A multiplayer game played over the network 121 can be implemented using several different approaches, which can be categorized into two groups: authoritative and non-authoritative. In the authoritative group, a common approach is the client-server architecture, where a central entity, such as the remote server 123, controls the whole game. Every client connected to the server receives data, locally creating a representation of the game state on their device. If a host or player performs or requests an action, such as moving from one point to another, that information is sent to the remote server 123. The server 123 may check whether the information is correct, e.g., did the host move to a stated location, and then updates its game state. After that, it propagates the information to all clients, so they can update their game state accordingly. In the non-authoritative group, there is no central entity and every peer (game) controls its game state. In a peer-to-peer (P2P) approach, a peer sends data to all other peers and receives data from them, assuming that information is reliable and correct. In the present example shown in FIG. 1, each of the player and host would be sending data to the other.

In an example scenario, the host may have the host device 120 mounted on their body in some way, such as with a headset or harness, and/or may include the camera 113A and/or the display 111A external to the host device 120 mounted to the host, for hands free operation and first-person view for the player during gaming. The user of the player device 110 may issue commands to the user where the host device 120 is at a remote location from the player device 110, connected via one or more communication networks, such as the network 121. The host device may be manned or unmanned as is the case where the host device is autonomous and/or robotic.

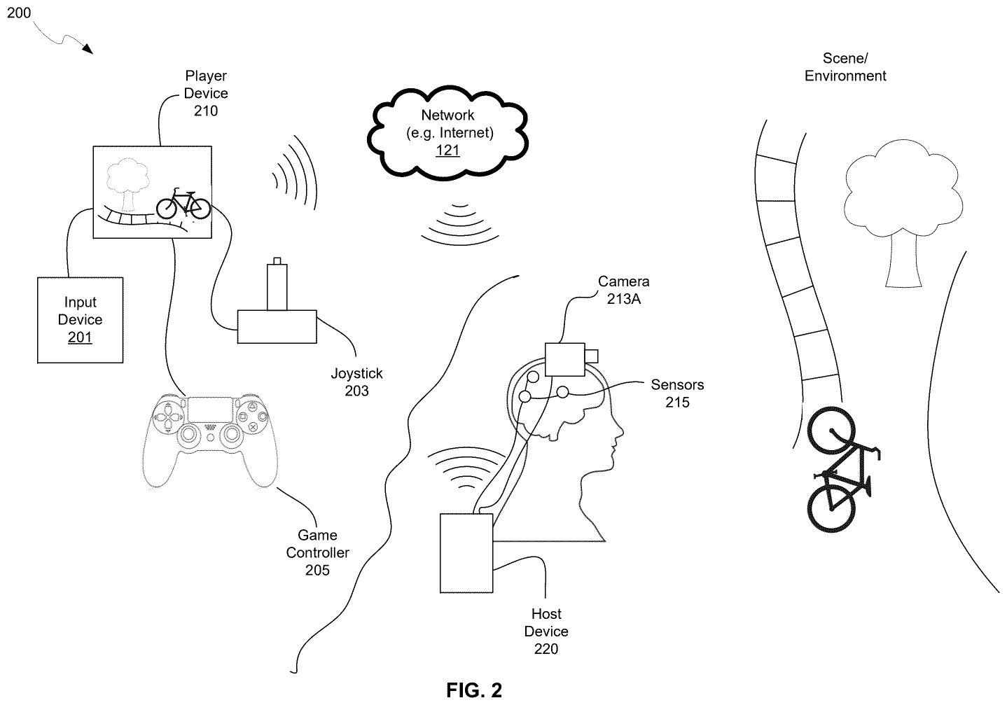

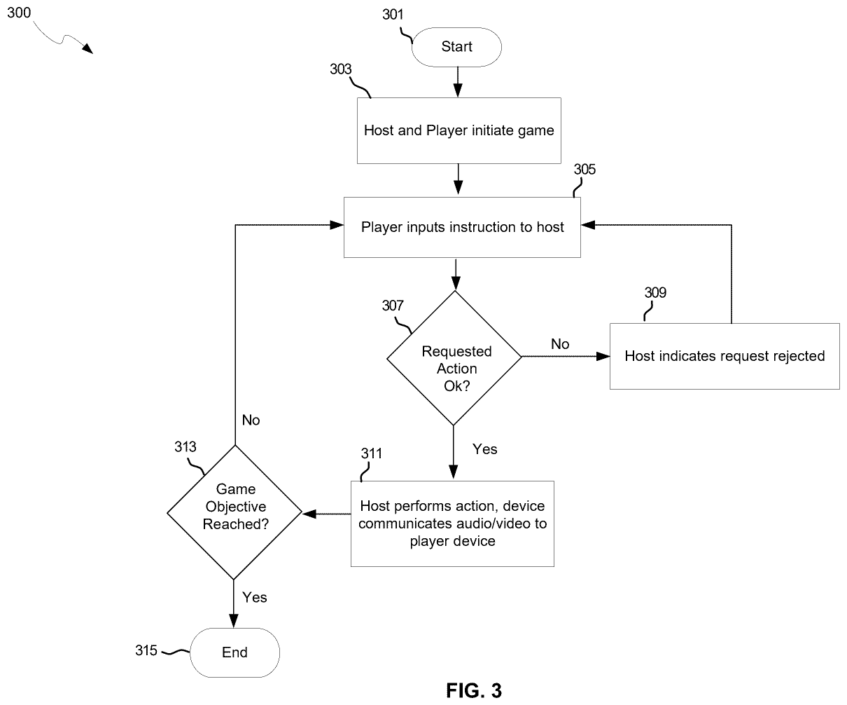

The commands may be communicated via various techniques other than verbal. For example, different tones may be utilized for instructing the user of the host device 120 to move in different directions, or perform an action, such as pick up or drop an object. In another example scenario, textual or other communicative symbols may be displayed on the display 111A and/or the display 111 of the host device 120 to provide commands to the user of the host device 120. The gaming commands and actions are described further with respect to FIGS. 2 and 3. These commands may also be transmitted to feedback devices of the host for example pressure inducers, motors, and/or direct brain stimulation.

Similarly, the user of the player device 110, or player, may communicate instructions verbally, textually, or graphically through the use of a microphone, touchscreen, keyboard, and/or brain recording device for example, although other inputs may be utilized, such as a joystick, trackpad, or game controller.

FIG. 2 illustrates a personal interaction game platform. Referring to FIG. 2, there is shown humaning game platform 200 comprising a player device 210, a host device 220, and network 121. The player device 210 is shown with an input device 201, joystick 203, and a game controller 205, although other accessories are possible. There is also shown host device 220 with a mounted camera 213A and sensors 215. The player device 210 and host device 220 may share any and all features of the player and host devices described with respect to FIG. 1.

The sensors 215 may be similar to the tactile sensors 215, and in this example are shown as attached to the host's head. In this example, various aspects of the host's environment and person may be sensed, such as temperature, sound, sweat, and even brain waves using EEG-type sensors, for example. Sensors may also be mounted elsewhere on the host's body for sensing movement, for example.

The term “humaning” from “human” and “gaming” is a gaming platform where a person may control another person like one would do in a video game. In this manner, reality is mixed with gaming or a digital gaming experience. Video games continue to become more lifelike and true to physics with improved graphics and processing capability. However, in a humaning environment, the graphics and physics are exact, as they are in the real world, because it can take place in the real world at least from the perspective of the host. Furthermore, the simulated intelligence of a character that is sought after in video game design is inherent in humaning environment because they can contain real humans.

A main component of a humaning game platform is low latency video, where it synthesizes and transfers experiences as they occur without delay or glitchiness. In addition, a more direct connection to the brain may be utilized, with virtual reality an intermediate step between these two levels of experience. An objective is to provide as rich an experience as possible, with video, sound, tactile, and even mental impacts/effects.

Other main components of humaning are the host and player, where the host agrees to be controlled or is autonomous and the player uses various levels of controls to do so. Feedback comprises, at least, audio/video but may also include other visual and/or textual inputs.

The commands in a humaning platform may be bidirectional—in that the player can control the host directionally, using a smart phone, drone, GoPro, infrared camera, etc. with live video streamed to the player with a controller, such as a joystick, game controller, or a directional pad. The commands may be transmitted to the host with visual, audible, or tactile feedback. In an example scenario, the host may wear a headset with audio, visual, and tactile inputs and outputs. Verbal instructions may be overlaid with specific tones in audible 3D space to indicate direction using time delays in left/right channels. Tones may also be associated with different instructions, such as “pick up,” “open,” or “close,” for example. Feedback may also be directly or indirectly communicated with the brain via targeted stimulation.

For visual feedback, instructions or directions may be displayed on the hosts display screen, a 3D arrow, or an arrow with text, for example. A tone or visual indicator may be used to teach the host certain commands so that they become more learned. Tactile feedback may be used so doesn't require sound or video for control. It is preferable to have the host perceive commands but without affecting the host's experience.

The phone/camera/etc. may be affixed or hovering above the host, such as with a drone. The player ultimately has a mental connection, inciting particular parts of the brain. In one embodiment, the game platform at the player end comprises one or more displays, speakers, and controls, allowing for frequently used instructions to be faster. Directional controls are an example of high frequency controls, which thus require as simple an interface as possible. Buttons for a momentary form of communication may be utilized, with sensitivity to control an amount, and a latching mechanism. Also a spot on the button to indicate direction may be utilized. For example, a player may press the top of a button to indicate to the host to move forward, and other characteristics of the motion may be used to indicate a speed, such as by swiping quickly upward to indicate to the host to run. Rotating cameras, 360° cameras, or a neural network capable of synthesizing views can also be used to allow real-time perspective changes without requiring the movement of the host. In a seamless embodiment, direct brain stimulation is used for transmitting visual stimuli and feedback control.

A “Do” button, in the joystick 203 or other control such as the input device 201 or the game controller 205, may be utilized for the most logical action presented, such as to open a door or push a crosswalk button that the host has approached. This provides instructional compression, which frees the player from using a cumbersome interface for high frequency instructions. However, this can lead to frustration where the desired action is not the first logical action, such as where the player wanted the door locked instead of opened. For these situations, a “?” Button may be utilized to open up an audio dialog or a menu of possible actions, for example.

The player can use the action buttons in various ways to quickly communicate their intent. The player can press and hold the “Do” button to access richer commands. The game platform should not limit what the player can do and accessing these commands can be cumbersome. Therefore, categorizing and sub-setting of commands may be utilized. Categorizing comprises selecting one selectable aspect that then opens up a list of possible actions for that aspect. For example, a body part, such as a hand, may be tapped on the screen, which then opens up options such as throw, grab, or push, and selecting a foot may open up a list of options such as jump, kick, or walk. Also, categories may be alphabetical, with the actions sorted by letter, but not limited to these forms of categorization.

Motions may be utilized by the player to indicate actions to the host, such as a swipe indicating a desired throw or jump, for example. Emojis may be utilized to indicate an emotional state.

Sub-setting may comprise bringing up a subset of options when presented with an object or location. For example, upon approaching a door, a list of actions relating to the door may be provided to the player. Object recognition in the game platform 200, in the player device 210 and/or host device 220, or a remote device, may be utilized to detect such structures. A dataset connects objects to actions and supplies them to the player. Alternatively, the player may tap an object on the screen, which then provides a list of options. Also, atypical or nonsensical actions may be included for entertainment purposes, such as for example smelling a door. A random button may be included for random actions that may be selected by the player for the host.

Moderation of the actions may be used to prohibit anything unlawful, uncomfortable for the host, improper, or against societal norms, for example. In addition, the host may have a reject button or similar input to indicate to the player that they do not want to, or cannot, take the requested action. If a player continues to request improper actions, they may be banned from the game, and proper behaviors may be encouraged with incentives.

Customizing controls—controls may be customized depending on the style of game play, in that the number of commands that can be captured, as well as rate of interaction, may be configured depending on the action of the game. For example, a sports game has a high rate of action, so controls need to be in front of player with no room for a menu or slow actions. So, in that style, for example, two buttons for left and right and a combined directional control for different punches in a boxing or martial arts type of game. This is in contrast to a strategy game, like escaping from a room with puzzles to solve with non-intuitive objects, meaning less of a requirement for fast controls but with more breadth of controls.

Action sub-setting—more in-depth actions. An adventure game is an example of using sub-setting—a movement, attack, and a pickup action, and then maybe “use” of what was picked up, such as a key that was picked up can then be used to unlock a door, for example.

Options for style of game play, such as camera angles and camera positioning for streamed embodiments are having the camera face outward, toward the person, split screen, multi-camera viewing that switches to other cameras, or drone based cameras, for example.

Set design—the range from physical world to digital world—the humaning platform may be in the real world but with digital world additions. A living room may be used as a boxing ring, for example, but with the ropes superimposed on the screen. Physical objects may be placed in the area in preparation of a game and digital set design would mean placing objects visually in the real world based on location, for example, scene recognition, GPS or other geolocation technology, etc. Other embodiments comprise a digital key or coin, base, or goal to reach. With real time video processing, the system may take the input video and stylize as the player desires—change the walls, to put the host in a comic book setting, etc.

State triggering—a special command may be available on either the host or the player side where, for example, a player may want to make a sudden and unexpected change to the state of the game, so a special command may be available for such a change. For example, if the host thought the game had been too uneventful and wanted a dragon to pop out, they could press a button relating to state triggering, and a dragon appears.

Changing the game state, for example to change levels, is accomplished either automatically, and/or user initiated. Automatic game state changes can occur based off of gaming metrics like number of points, host location, time remaining, number of players, upon accomplishing of goals, etc. User initiated state changes can require input from either the player or the host via a button, command or other form of input. Both user initiated and automatic state changes can also occur simultaneously such as when a player enters a location and the host decides to advances the gaming narrative to the next phase.

With respect to the application interface, the fundamental parts of this interface are the host interface and a marketplace where a user can select what game they want to play. Capabilities may be optimized for the experience of the players and the host. A user may see games, ratings, previews, screenshots, and may allow for game suggestions from players or hosts, that can then be filled by hosts, and include payment structures, suggested by the marketplace.

Costume play may be incorporated into the ecosystem for people that like to dress up as comic book characters, animals, etc. and the system allows them to be that character. Alternatively, the host's appearance may be enhanced with physical and/or digital characteristics like outfits, weapons, etc. as seen by the player on the player device 210.

Scoring may be based on the objective of the game and can be triggered by the host themselves, the player, other players, or automatically detected.

In addition to gaming, the ecosystem can request or control an action that the player would like, but can be more utilitarian instead, such as in a delivery or pick up something at a store for them. For example, a player may direct a host through a store or shopping mall, to one or more desired objects, or imply to browse through the store or stores. This may be particularly useful for persons that have limited mobility. Special projects-someone needs to people watch for marketing purposes and can send one or more hosts over to a mall, for example, to observe shopping activities at a particular store.

The gaming platform also has therapeutic purpose. For example, people that suffer from certain psychological conditions where social situations create a lot of anxiety, may be helped by controlling another person while still in a safe isolated environment, so that they may build experience with social interaction. Also depressed individuals may benefit from the interactions enabled by humaning through positive and entertaining interactions with others.

In operation, a host may wear and/or carry the host device 220, camera 213A, and sensors 215 while in a scene or environment, as shown in FIG. 2. The visual and physical aspects of the scene may be captured and/or sensed by the host device 220, camera 213A, and sensors 215 to be communicated to the network 121 to the player device 210. The player may control the host using the player device 210 and input device 201, joystick 203, and/or game controller 205. As the host encounters structures and/or people in their environment, the player may dictate responses to the host using the device player and communicated to the host device 220 via the network 121.

Commands may include positional change instructions or specific actions to be taken by the host, such as moving in a desired direction at a desired speed, pick up an object, or speak to another person nearby, for example. Audible and/or visual commands may be utilized to provide these commands to the host. An audio/visual command may comprise, for example, an image of the scene being displayed on the host device 220 with a target location marked and an audio command may be played “Ride the bike to the tree while singing your favorite song.” The host may then, assuming these actions are within the established guidelines, take these actions, with video captured by the camera 213A being displayed on the player device and audio of the host singing captured by one or more microphones in the host device 220 being played on the player device 210. Once this action is performed, points may be awarded, which may be accrued until a level is reached and different actions may then become available, for example. If the commands made by the player are not within guidelines, for example if the bicycle is not owned by the host and the action could be considered theft, the host may indicate to the player that the command is rejected.

The network 121 provides communication between the player device 210 and the host device 220 and may include one or more cellular services and one or more WiFi networks, for example, for communicating over the Internet between devices. Accordingly, the network 121 provides a communication path for audio/visual data, as well as sensor and text data between devices.

FIG. 3 is a flow chart for a personal interaction game platform. Referring to FIG. 3, there is shown process flow 300 starting with start step 301 followed by step 303 where a host and a user agree to a humaning game. Once started, the player inputs one or more instructions to the host in step 305. If, in step 307, the requested action is not prohibited and is otherwise acceptable to the host, the process continues in step 311, where the host performs the action. The host device may send audio/video and other sensor data to the player device via the network so that the player experiences as much of the scene as possible. If, in step 307, the player instruction is prohibited, not possible, or otherwise not acceptable to the host, a rejection indication may be communicated to the player moving back to step 305, where one or more different instructions may be input. The player can request again and/or make an offer in order to get the action performed which may include a financial payment.

If after step 311, in step 313, the game objective has not been reached, the example steps proceed back to step 305 for more inputs, but if the game objective has been reached, the process ends at step 315.

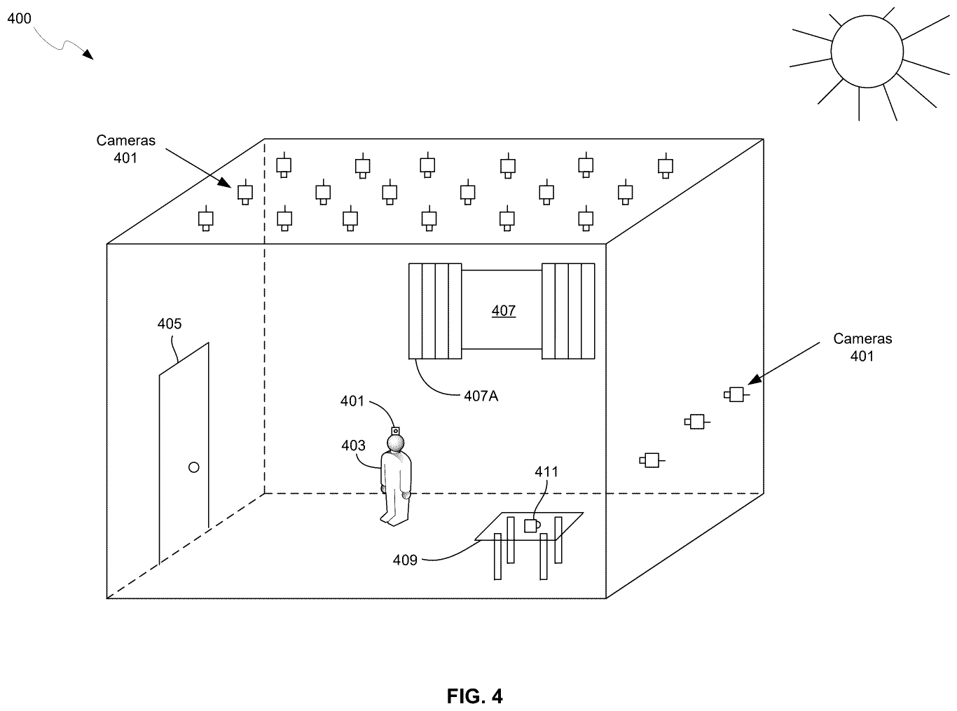

FIG. 4 illustrates a gaming platform interactive scene generation. Referring to FIG. 4, there is shown room 400 with cameras 401, a person 403, a door 405, a window 407 with curtains 407A, a table 409, and a cup 411. The cameras 401 may be operable to record images and video from the room 400 for subsequent scene generation.

In this regard, in various embodiments based on the present disclosure, recorded footage (e.g., captured images and/or videos) may be used in improving gaming platforms and applications, particularly for use in setting and training neural networks or other computational algorithms with similar goals (herein referred to topically as machine learning, neural networks, AI models, etc. for simplicity) that are used in the gaming applications—that is, neural network based game engines. The recorded footage may be fed into a neural network, along with additional parameters and/or information, to enable the neural network to output frame(s) of video (or comparable information for simulating an experience in an environment, such as wireframes, rendering parameters, tensors, images, neural stimulation, etc.), which depends on the state and user controls, for use in the gaming applications. Some embodiments of the present disclosure may be directed to the gathering of the data as well as use of that data, such as to make an interactive section of video and/or to train a neural network to make it fully interactive.

To that end, suitable settings, such as the room 400, may be used in conjunction with obtaining the recorded footage. In this regard, the room 400 comprises a scene (also referred to as “setting” or “environment”) with objects and characters that may be interacted with by a game player. The scene (a slice of reality) may have a state—objects, characters, etc. Each state may have associated therewith a probability of being in that state. Further, to turn the scene into footage that may be used in a game, the scene may be digitized. For example, the scene may start out with a set, comprising static objects, such as the room 401 and window 407, for example, and dynamic objects, such as the curtains 407A that may move in the breeze, or the cup 411 that can be moved, or the door 405 that can be opened, closed, and/or locked. The movable items may have different states (e.g., door being open or closed) and probability of being in those states. For example, the cup 411 may be in different locations with different orientations. In such an example scenario, the environment is mainly static with some dynamic motion possible such as the waves of a beach which can be seen through the window.

To digitize the scene, the video capture may include and show the room 400 from every point in the room, and in every view/orientation, including roll, pitch, and yaw. In addition, for full reality, the capture should include additional information such as color information, which may help determine depth information. Ways of capturing this include, but are not limited to using 360 degree camera(s), moving camera(s) that may traverse (e.g., in back and forth pattern), or an array of cameras 401 as shown in FIG. 4. It should be noted that the number of cameras shown is merely an example, and more or fewer cameras may be used depending on the size of the room and/or parameters relating to the cameras, such as camera resolution and field-of-view, for example. Furthermore, a camera at every single height is not necessary, as different points-of-view may be generated from a subset. Similarly, an environment can be created from zero images where it is merely described, digitally constructed, or created directly from biometric information such as non-invasive or invasive neural activity.

In various embodiments, the recorded footage—e.g., acquired digital representation of the environment 400—may be fed through a machine learning or artificial intelligence (AI) algorithm, to generate a dataset comprising one or more frames, and given any coordinate, the system may be operable to generate a view based on this dataset. A sparser version of the dataset may not necessarily have every point, but may have points of interest with interpolations between. In this regard, the footage may be recorded in sparse manner—that is, with gaps in time and/or space—but may be then converted to a representation capable of complete coverage, such as using neural networks.

In some instances, objects may use more calculations to cover all possible locations, orientation, and/or motion, for example. In fixed point action, an interaction with an object (e.g., a door, a light switch, a gun, etc.) occurs from a fixed point. Such interaction may be recorded to capture what is being done with the object (e.g., opening the door, turning off the light switch, picking up the gun and/or using it to shoot, etc.). Thus, when moving to such fixed point, there would a recording of the action that may be undertaken with particular object at that point. For example, when opening the door 405, with two enemies present, different options may be filmed, whether the game player, represented by the person 403, shoots at them or not, closes the door, or runs away, etc.

Further, objects and/or environment may need to be able to maintain state, such as when the user picks up something and puts it back down or instead takes it with them, if the user, or other users look where it was, it needs to no longer be visible at that location. Inconsistencies may be avoided by recording or generating the environment with the object in its different states.

In addition to captured information, traditionally generated material may also be added or removed. For example, a three-dimensional (3D) computer generated ball can be added to the floor, which moves when touched by the player. Similarly, a portion of the captured environment may be removed or modified to enhance the experience—e.g., similar to set extension in films.

Another layer of the dataset is characters, which of course can be fixed or moving around. Probability of states of characters may be calculated and captured from all angles. In this regard, in some instances, multiple cameras may be needed to fully capture the scene. One example is ballroom dancing, where it may not be practical to utilize one camera traversing the space as described above. In such cases, there may be a plurality of cameras spaced throughout the room, as shown in FIG. 4. Cameras maybe affixed in the ceilings, walls, or on the floor for example, and/or dynamic such as on people, or a swarm of drones. With an individual camera or such an array, 3D imagery may be generated. Some of the cameras may be set up on a grid either fixed or dynamic, to optimize operation.

As shown in FIG. 4, the cameras 401 may comprise 360 degree cameras spaced evenly on the ceiling, looking downward, and therefore may have views from all different angles. However, the disclosure is not limited to such implementations, and other solutions may be used—e.g., use of various combinations of camera(s) and mirrors to obtain full (or almost full), a mirror ball on the ceiling with a camera on the floor, rotating cameras, 360 degree cameras on robots or drones, etc. Images may then be captured from different points of interest and interpolated (e.g., using computation algorithms such as neural network models) between all of them to get all the directions and locations. Further, in some instances models trained with geometric inference (which is what a human can do) may create a movie (e.g., a moving scene) using the captured images.

Transitions between cameras may be interpolated, and then it may be determined how to do the transitions. In this regard, while it may be possible to record and then playback, this may not be possible or convenient to do in a dynamic scene, thus it may be necessary to interpolate. This may be done by training in a neural network and then generalizing to show traversing the scene. For example, the cameras 401 may be configured to capture full range view(s)—that is, they may be 360 degree cameras, thus enabling producing views from various positions, and some (or all) angles. This information may be interpolated, such as using computer algorithms and/or machine learning techniques to provide seamless movement and/or novel perspectives.

In various embodiments, AI models may be used, such as in conjunction with the use of neural networks in generating the frames. Such AI models may be trained in the course of the training of the neural networks for video generation operations. The AI models may be configured for determining and/or predicting various aspects associated with features and/or objects of the environment, such as objects in the environment. Further aspects of the AI model comprise movement, occlusion, object rendering from different angles, lighting changes, looped dynamic movement (e.g., curtains 407A swinging)—which can loop in each frame for accurate rendering. Different time steps may be utilized for different objects depending on their motion. The AI model may provide outside-in views, or character view facing outward. In another example scenario, the AI model may comprise interactive volumetric video, where an object and/or its movement may be recorded somewhere else, then placed in the environment. Similarly, face swapping may be enabled by this process, where another face, such as a famous actor, may be placed into the video of the character.

In an example embodiment, the AI model may train with geometric inference—going from a point and moving from it, such as placing a character at the table 409 and drawing the room from this direction. The coverage of the environment may range from sparse to complete. Neural network inference can predict the next frame given a certain frame. In this regard, images and related information may be captured in sparse manner—that is, providing sparse coverage, with gaps in time and/or space, and the footage may be then converted to complete coverage, using computation algorithms such as neural networks.

In some instances, neural networks and/or AI models may be configured to provide information relating to real time lighting. The neural networks and/or AI models may be configured to simulate camera movement, such as in a walking like manner. The neural networks and/or AI models may be configured to provide AI powered actions, movement, expression, speech, etc. The neural networks and/or AI models may be also configured to provide information relating to such parameters or characteristics as orientation in the X, Y, Z directions and rotations, time and state, surface properties, light interactions, etc.

In some instances, scanning techniques such as photogrammetry may be used to capture properties of a geometric element such as an object, a person, a scene, etc. These properties may include but are not limited to color, geometry, and/or other material properties. Following capture, these properties may be fed into a neural network to complete and/or augment data, such as in order to have a neural representation of the geometric element.

Geometric elements can include deformable and/or non-deformable time-dependent three-dimensional (3D) models, which make them dynamic. Examples include a snow ball, or a human character, which perform morphological changes when interacted with such as deformation when touched, as well as changes due to their own properties (e.g., the snow ball melting due to its temperature difference with the environment, the human character deciding to sit on a chair and remove its shoes, etc.).

In some instances, a robot (or other suitable autonomous moving objects) may be used to move around for capturing the environment and/or transmitting what is being captured live. When captured for use in a prerecorded experience, state and/or the properties associated with objects can be realistically tracked and simulated in a variety of ways. These can include but are not limited to using a database, data structure, recorded footage, footage of limited perspective (like that in traditional film), a plurality of footages of which one is chosen based on player interaction, computer vision algorithm, and/or neural network.

In some instances, the environment may be represented with particles or shapes and properties or equations. Particles have a very small volume with limited geometry, while shapes have a larger volume capable of complex geometries. Properties or equations can range from just simple details like color through complex such as those governing interactions of sub-atomic particles. The particles or shapes may be individual or grouped to form various representations that share properties or equations like state for example. In such embodiments, the output may be created by evaluating the equations or state of particles or shapes (such as their positions, colors, trajectories, etc. in the environment) in order to create a simulated reality. The simulated reality can be capable of representing such things as space, time, and interaction with the environment.

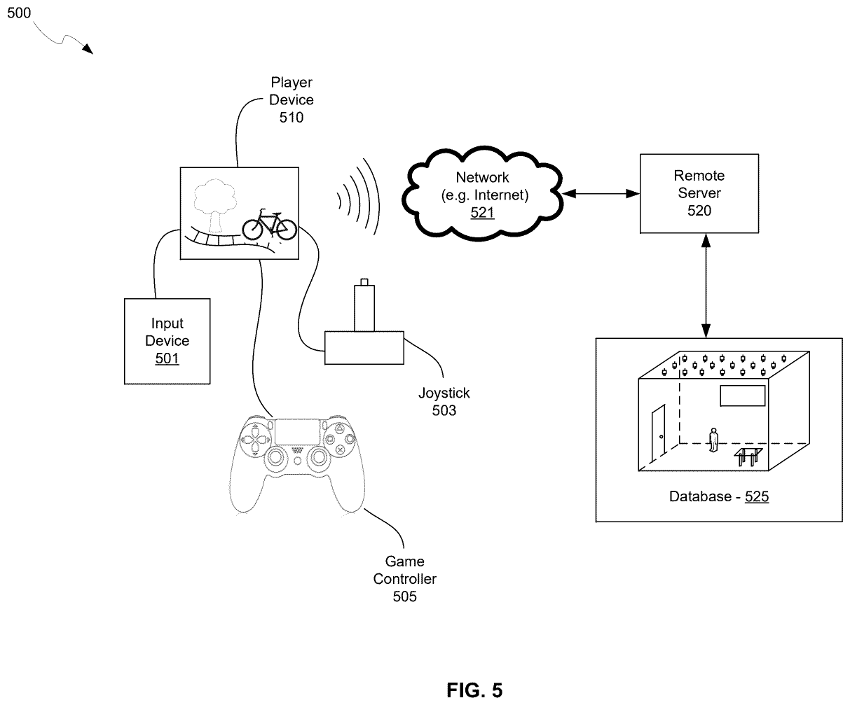

FIG. 5 illustrates an interactive gaming platform using a reality-based generated scene. Referring to FIG. 5, there is shown is a gaming platform 500.

The gaming platform 500 may be substantially similar to the game platform 200 of FIG. 2, and may generally operate and may be utilized in substantially similar manner—particularly with respect to facilitating and/or supporting gaming related operations and functions—as described above with respect to FIG. 2, for example. However, the gaming platform 500 may be configured for supporting interactive gaming using reality-based generated scenes, particularly based on use of artificial intelligence based processing (e.g., neural networks) as described herein for scene generation and interaction.

As illustrated in FIG. 5, the gaming platform 500 comprises a player device 510 and a network 521. The player device 510 is shown with an input device 501, a joystick 503, and a game controller 505, although other accessories are possible. In this regard, unless described otherwise, similarly named components are substantially similar, and may operate in substantially similar manner. There is also shown a remote server 520, which may maintain and/or interact with a database 525. The player device 510 may communicate with the remote server 520 via the network 521. The database 525 may comprise recorded images and videos, and/or related information, as described herein.

In operation, the player device 510 may be utilized for gaming based applications. In such instances, during such gaming applications, the player device 510, and the gaming platform 500 as a whole, may provide interactive reality-based generated scenes, particularly based on use of artificial intelligence based processing (e.g., neural networks) as described herein for scene generation. In this regard, scenes displayed during games, and/or visual and physical aspects thereof, may be generated based on recorded footage (e.g., pictures and/or videos) captured in suitable environment, such as the room 400 of FIG. 4. This recorded footage, and/or information relating thereto, may be maintained in the database 525. The recorded footage may enable generation of sequence of frames for display during the gaming applications. As noted, artificial intelligence based processing, particularly use of neural networks, may be used for such scene generation. This may be done in one or both of the player device 510 and the remote server 520.

Accordingly, during gaming operations, the player device 510 may (but is not required to) communicate with the remote server 520, via the network 521, to obtain recorded footage from the database 525 and/or scenes generated based therein via the remote server 520. In this regard, the network 521, similar to the network 121, may provide communication between the player device 510 and the host device 220, and may similarly include one or more cellular services and one or more WiFi networks, for example, for communicating over the Internet between devices. Accordingly, the network 521 provides a communication path for audio/visual data, as well as sensor and text data between devices.

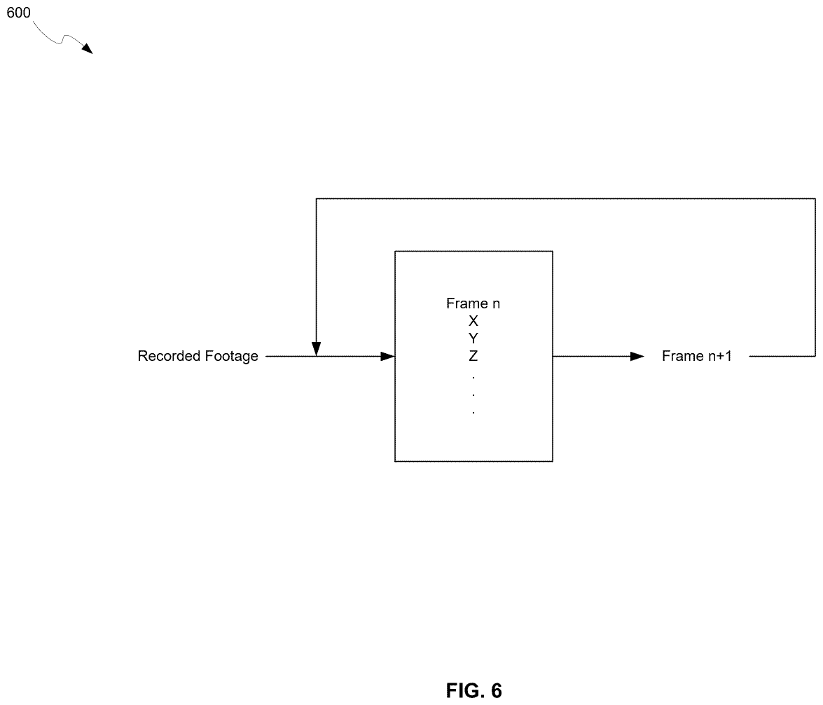

FIG. 6 illustrates a flowchart of machine learning scene generation. Referring to FIG. 6, there is shown a neural network 600 and an example use thereof in generating video frames.

In this regard, in accordance with embodiments based on the present disclosure, recorded footage may be fed into neural networks, such as the neural network 600, to enable training thereof, so that the neural networks may output video frames in interactive manner, as described herein. In this regard, once trained, the neural network may generate images and/or video frames, such as for use in gaming applications. The neural network 600 may be generated and continually trained, such as using captured and/or generated images and/or videos (e.g., using room 400 of FIG. 4). Once trained, as illustrated in FIG. 6, the neural network 600 may generate subsequent video frames (e.g., frame n+1) based on current (prior) frames (e.g., frame n). In this regard, recorded footage may be fed into neural network 600, which may then output a frame of video that depends on the current frame and state variables, but with adjustments thereto being made by neural network 600 based on training. As described herein, the neural network 600 may use AI modeling for determining adjustments relating to placement and/or movement (e.g., with respect to orientation in the X, Y, Z directions), time and state, occlusion, surface properties, object rendering from different angles, lighting changes and/or interactions, players, looped dynamic movement, etc. The neural network 600 may then apply the adjustments when outputting the subsequent frames.

In embodiments based on the present disclosure, gaming platforms may incorporate interactive neural engines. In this regard, an interactive neural engine may be used in providing artificial intelligence (AI) based rendering of the game—that is, in the construction of an interactive experience that mirrors the fidelity of reality. In particular, the objective of using such interactive neural engines is to present a high fidelity visceral interactive experience, using one or both (at any degree of combination) of real content and generated content. In other words, the interactive neural game engines may facilitate rendering of and interactions with game environments and/or game entities. In this regard, game entities may comprise characters in the game, objects and/or features in the game environment, etc. To that end, interactive neural engines may generate and/or utilize lists and properties of lists corresponding to a game environment and/or game entities used in the game (e.g., of game characters, and properties thereof, such as voice, etc.).

The interactive neural engine may be configured to handle or support handling of rendering and controlling of the game environment (including creating thereof) and changes to the environment, rendering and controlling of game characters and changes thereto (including actions thereby), rendering and controlling of interactions between the game characters, other game entities, and the game environment, rendering and controlling of movement and perspective of game characters and other elements (or game entities) in the game environment, and the like. With respect to the creating and rendering of the game environment, real content, digital (e.g., computer generated (CG)) content, and/or mixture of both may be used. The environment can be comprised of features such as objects. The location of the features may be fixed or not fixed. The features may be on a continuum between fully animate (exert forces and react to forces) to full inanimate (only react to forces). With respect to the current state of the environment, it may be changed via interactions (e.g., interactions cause changes to the state of the environment). Further, an interactive neural engine may enable experiencing the current state of the environment in various suitable ways, which may span a wide continuum of options—e.g., through screen, VR headset, all the way to direct neural stimulation.

The environment (or at least portion thereof and/or features therein), and interactions in the environment may be captured in various suitable ways—e.g., via camera(s), neural activity, etc. Further, different degrees of capturing may be supported—e.g., complete capture, partial capturing (with remaining elements, features, and/or details synthesized), to no capturing (none), with all required elements, features, and/or details synthesized. In addition, in some instances, one or both of the environment and the interactions may be augmented.

With respect to movement and perspective (e.g., of game characters, or objects that may be operated during the game), and object interaction, the interactive neural engine may be configured for controlling and facilitating rendering of both, and may further provide controls for both. Different types of changes may be supported and/or provided, including, e.g., stateless changes (time independent), and stateful changes (time dependent). In this regard, the stateless changes may be in response to interactions whereas the stateful changes may, for example, be the result of passage of time. In some instances, some changes may be both stateless and stateful—that is, the result of both of interactions and passage of time.

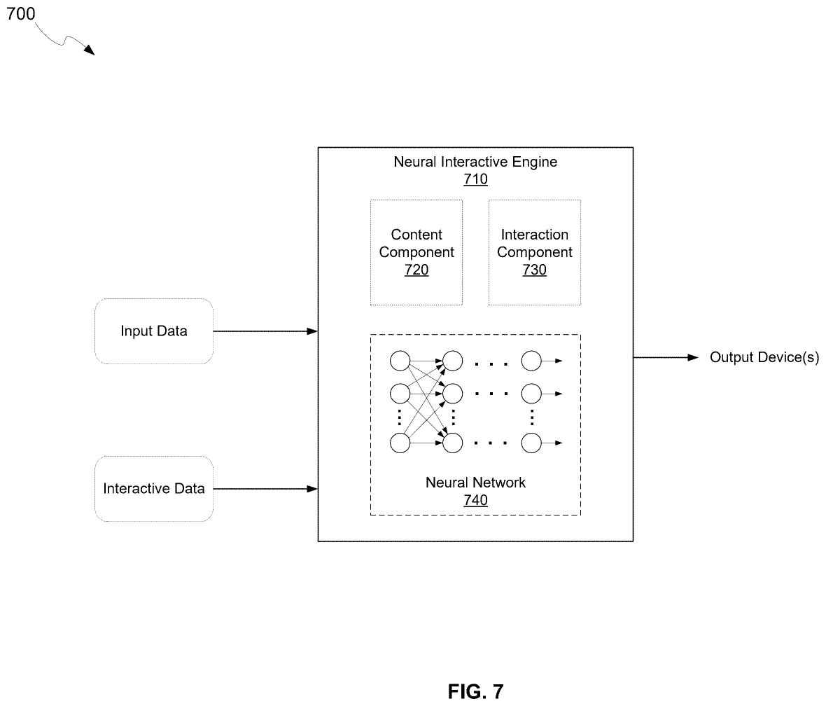

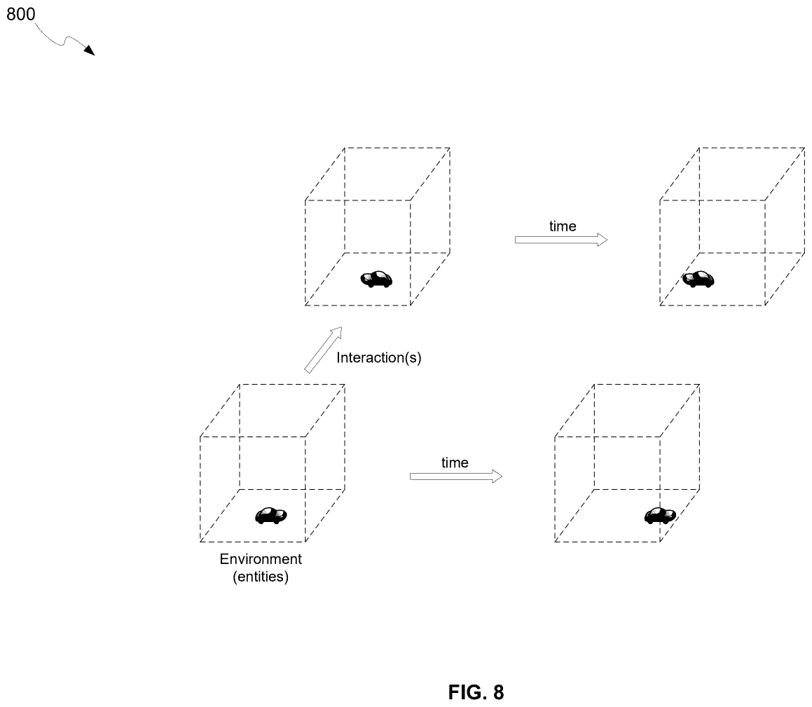

In various example embodiments, the interactive neural engine may be implemented such that it has two (2) main components: 1) a content component, and 2) an interaction component. The content component is responsible for providing the content of the game, using content generation and/or synthesis, for example. In this regard, with content generation the content is generated by the interactive neural engine, whereas with content synthesis real content is used, which is then synthesized by the interactive neural engine for use in the game. The content may be real content, computer generated (CG) content, or any combination of real content and computer generated (CG) content—that is, real content 0-100%, and CG content 0-100%. The interaction component handles interactions by and/or with the game entities, and/or interactions within the game environment as a whole. The interactive neural engines and details related thereto are described in more details below with respect to FIGS. 7-8.

FIG. 7 illustrates an example interactive neural engine used in an interactive gaming platform. Shown in FIG. 7 is a gaming platform 700 (or portion thereof), which is substantially similar to the game platforms described herein (e.g., the game platform 200 of FIG. 2, the game platform 500 of FIG. 5). However, the gaming platform 700 additionally may be configured to implement and/or support use of artificial intelligence (AI) and/or machine learning based techniques to enhance and/or optimize functions and/or operations in interactive gaming solutions, such as with respect to generating gaming environments, generating and controlling game entities (including game characters), etc. This may be done by use of neural interactive engines as described herein.

For example, as illustrated in FIG. 7, the gaming platform 700 incorporates a neural interactive engine 710. The neural interactive engine 710 may comprise suitable circuitry, interfaces, logic, and/or code that may be configured to provide AI-based rendering and control of game environment and game entities, and/or to implement the various components and/or functions attributed thereto, as described herein. In this regard, the neural interactive engine 710 may be implemented using dedicated circuitry and/or other resources that are added into the gaming platform 700 to incorporate neural interactive engine based functions or operations as described herein. Alternatively, the neural interactive engine 710, or at least portion thereof, may be implemented using existing circuitry and/or other resources that are already used in the gaming platform 700. Further, while the neural interactive engine 710 is illustrated as a single block, the neural interactive engine 710 may be implemented in a distributed manner—that is, where different elements or components implementing the functions or operations of the neural interactive engine 710 as described herein are spread across several, interconnected computing devices or systems, and some of which may be remote.

As noted, interactive neural engines, such as the interactive neural engine 710, may be configured to have two (2) main components: 1) a content component 720, and 2) an interaction component 730. With respect to content component 720, as noted the content component 720 is responsible for providing the content of the game environment. This may be done using content generation and/or synthesis. In this regard, the content may be real content—that is, actual content captured by suitable means, which then may be synthesized for use in the game, and/or computer generated (CG) content, or can be any combination thereof—that is, the real content may be in the range of 0-100%, and CG content may be in the range of 0-100%. As such, the amount of preexisting content (objects, environments, motion, materials, properties of light and sound, performances, characters, dynamics, behaviors compositions, etc.) may vary.

Whereas in conventional solutions content is typically generated using traditional game engines, 3D rendering software, basic photos and videos, interpolative photos and videos, etc., solutions based on the present disclosure use content that is generated and/or synthesized. In this regard, synthesis refers to taking something existing (e.g., first content) and doing something with it to provide desired output (e.g., second content). The degree of synthesis (from 0% to 100%) refers to amount of preexisting content used. So at 0%, no preexisting content is used (and thus all content is generated), whereas at 100% all content output is synthesized from preexisting content. Thus, the content component 720 of the interactive neural engine may allow providing content based on continuum between full generation to full synthesis—that is, content generation→synthesis: 0%→50%→100%. The interactive neural engine, and the game platform as a whole, may be configured to handle different degrees of synthesis, such as by performing different functions and/or operations.

For example, for 100% synthesis (i.e., full synthesis), preexisting content is captured and synthesized for rendering. Properties such as, but not limited to, light and sound, are measured in an environment to create a representation of the environment and all that contained therein. In one such embodiment: a camera is used to record rectilinear projections of light referred to as (images) associated with a point in space and time. These images are then stitched together to construct spherical equirectangular projections (referred to as 360° images). This may be done to many (if not all) of the spots in space. These 360° images are then accessed corresponding to a simulated traversal of 3-dimensional space and 1-dimensional time, resulting in a recreation of being inside the original environment. Assuming the environment is static—that is, ignoring the time-dimensional—the images may be combined in an input/output to allow movement in all directions (3D). The input/output device may be a computer (for now), but other devices may be used (e.g., VR headset, etc.).

Additional details, features, and/or tools may include: 1) use of microphones; 2) robotic precision; 3) inside/outside; 4) outside/inside; and 5) CG or mix of CG and real as described above. In this regard, microphone(s) may be used in a similar manner as the camera(s) for capturing audio. With respect to robotic precision, a camera (and/or a microphone) may be attached to a robotic or autonomous moving platform that may move in different spatial directions, to move the device (camera, microphone, etc.) around the environment. Subsequently fewer photos may be used. In inside/outside capturing, the capture takes place from inside the environment pointing outwards, such as by use of multiple of cameras in the environment. Conversely, for outside/inside capture takes place from outside the environments pointing inwards. These captures may be used to simulate movement inside the environment; and/or mixed with CG as described above.

For 95% synthesis, sparse 360° images associated with a point in space and time combined with an interpolation algorithm (such as neural network, computer vision, or mathematical based, etc.) are used to allow the traversal of the environment through space and time. For 75% synthesis, camera perspectives may be used to generate enough content to enable traversal of the environment through space and time (such as a ceiling combined with trained traversal perspectives).

For 50% synthesis, content may be captured from a single perspective moving through space and time, and the process is repeated. The neural rendering engine uses multiple instances of the captured content to generate perspectives that were not captured. (Live gameplay sessions v. pre-recorded). For 25% synthesis, it may be same as 50% synthesis, but does not require repetition of capture.

For 10% synthesis, the simulation may be constructed from various trained or existing assets. For a 5% synthesis based embodiment, sparse input such as, but not limited to text, image, video, and/or data that represents aspects of the desired simulation are processed as inputs to the rendering algorithm to create the simulation.

For 0% synthesis (that is with 100% content generation), the interactive neural engine may be capable of producing simulations without any external input. One way of achieving this is by training a neural network on a body of content, allowing the neural engine to choose a random starting output, allowing the user to perform an interaction, and generating the proceeding outputs based on the previous output and interactions.

Following the creation of the simulation, it may be tuned manually, semi-atomically (proposed changes are approved), or automatically (optimization and data metrics cause changes).

With respect to interaction component 730, as noted the interaction component 730 is responsible for handling interactions by and/or with the game entities, and/or interactions within the game environment as a whole. The interaction component 730 provides an interactive experience. In this regard, conventional solutions, if any exist, may entail use of computer generated (CG) graphics, or captured video (e.g., via full-motion video (FMV) or the like). However, with cut-scenes and similar approaches, the user/player does not have much freedom. As such, conventional solutions either: 1) use real content (e.g., film clips or the like) but allow for no-interaction, or at best slight interactivity (e.g., when using FMV software); or 2) use CG (non-real) graphics, which do not have high fidelity, but may allow for more interactivity. However, even with such increased interactivity, game entities' interactions are still limited, as behaviors typically must be pre-made/pre-set (games have to be fully programmed, so it limits the number and/or scope of behaviors that may be assigned to characters or other game entities in the game).

Solutions based on the present disclosure improve that by bringing granularity to any point in space, and allow full interactivity (and ability to change anything) in the environment. In this regard, with fully interactivity characters may interact fully without requiring pre-programming—that is, game entities (characters or otherwise) may be capable of constructing and providing a full interactive experience that mirrors the fidelity of reality. This is done by use of artificial intelligence (AI), such as by use of neural networks. In this regard, AI may be used in controlling and rendering (that is, providing AI rendering) of the interactions. Such AI rendering of the interactions may use one or both of real content and CG content (including any degree of combination/composition of both—that is, 0-100% synthesis).

The interaction component 730 of the interactive neural engine may support interactions on a continuum between full interaction (100%) and no interaction (0%)—that is, interactivity from 0%□100%. As such, the interactive neural engine, and the game platform as a whole, may be configured to handle different degrees of interactions, such as by performing different functions and/or operations. Further, any combination of content generation/synthesis (0% to 100%) and interaction (0% to 100%) may be done.

For 100% interactions, aspects of the environment may be captured and/or rendered in advance. Integration with the space time data may be performed using precise space time coordinate tracking (x, y, z, t) during the performance of the interaction. When a user triggers this interaction (click, etc.), the view is transitioned to the coordinates corresponding to the beginning of the recorded interaction, and the interaction is performed. The state of the environment may or may not be updated. If the ending state following the interaction is different from the starting state, then this state change must be reflected in the simulation. For example, a user moves through a room in the simulated environment towards a closed door, clicks the door handle, triggering the recording interaction of opening the door to be played. Now moving through the room, the door is seen as opened, where previously it was closed.

For 95% interactions, aspects are sparsely captured/rendered with algorithm use to interpolate between ground truth data. For 75%, it may be the same as 1-75%, transformed from alternative view(s). For 50%, it may be the same as 1-50%, where interaction and state internalized inside the algorithm (neural network, etc.) may be trained on interaction data, such as via stimulus response footage.

With respect to characters (or game entities in general), the interactive neural engine may be configured to perform various functions and/or to utilize various techniques to facilitate AI based generating, rendering, and controlling of characters (or game entities in general) and/or interactions thereof (and/or therewith). In this regard, the interactive neural engine may be configured to utilize mixture of real and CG content, including with respect to interaction rendering. In this regard, various suitable techniques may be used, such as photogrammetry, motion capture, virtual production, etc. Further, the interactive neural engine may be configured to utilize learned parameters (e.g., material properties, scene compositions, movement patterns, etc.), such as from video, to generate physically plausible behaviors or realistic deformations, interactions, etc. Alternatively or additionally, in some instances, artistic versions may be used, which may relax learned parameters. Other functions and/or techniques that may be utilized may comprise next frame prediction, and training. In this regard, training may include segmentation and prediction to learn the state transformation (from preceding state to new state).

In various implementations, the AI based generating, rendering, and controlling of characters (or game entities in general) and/or interactions thereof (and/or therewith), as performed in the interactive neural engine, may be state-based. In this regard, each game entity may have an internal and external state (set of variables). Internal states dictate behaviors and interactions which modify the internal and external state of itself and other game entities. This is particularly the case for anything made up of multiple parts, where each part may have corresponding state(s). As noted, training may be used, which may include segmentation and prediction to learn the state transformation (e.g., from a preceding state to a new state). Internal state and state transformations drive behaviors. In some instances, suitable output devices may be used to encode information into simulations. A global state may also be determined and used. The global state may be determined and/or generated based on the game entities. For example, the global state may be made up of the game entities' external states, which may, e.g., encode the perceivable time dimension of the present. An example of game environment (or portion thereof), and state-based rendering of a game entity therein is shown and described in more detail with respect to FIG. 8.

As noted above, the neural interactive engine 710 may be configured to implement and/or use artificial intelligence and/or machine learning techniques to enhance and/or optimize functions and/or operations in interactive gaming platforms, such as by use of deep learning techniques and/or algorithms. For example, the neural interactive engine 710 may be configured to use neural based techniques, such as by use of neural networks—e.g., one or more of a convolutional neural network (CNN), a generative adversarial network (GAN), residual channel attention network (RCAN), a residual dense network (RDN), etc.), and/or may utilize any suitable form of artificial intelligence based processing techniques or machine learning processing functionality for use in conjunction with the neural networks (e.g., for content generation and/or synthesis, and/or for AI-based rendering in response to interactions).

As illustrated in FIG. 7, for example, the neural interactive engine 710 incorporates a neural network 740. In this regard, any suitable neural network may be used. The neural network 740 may be made up of, e.g., an input layer, an output layer, and one or more intermediate layers in between the input and output layers. Each of the layers may be made up of a plurality of processing nodes that may be referred to as neurons. For example, the neural network 740 may include an input layer having one or more neurons, an output layer having one or more neurons, and one or more intermediate layers each having one or more neurons. In this regard, each of the neurons of the input layer may be configured for processing or otherwise managing information for one or more game entities, particular features, attributes, or characteristics of game entities, etc.

Each of the neurons of the output layer may be configured to generate content and/or content-rendering related information relating to the game environment as a whole, portion of the game environment, particular game entities, particular aspects of game entities, etc. Each neuron of each intermediate layer may perform a processing function based on one or more inputs, including inputs from one or more of a plurality of neurons of an upstream layer, and/or to pass the processed information to one or more of a plurality of neurons of a downstream layer for further processing. Additionally, one or many neural networks may be used in a suitable computational arrangement in a similar fashion.

In some implementations, the neural interactive engine 710 may be configured to perform or otherwise control at least some of the functions performed thereby based on a user instruction via suitable user input device(s). As an example, a user may provide a voice command, gesture, button depression, or the like to issue a particular instruction, such as to initiate and/or control various aspects of the AI-rendering related functions (or other functions) of the neural interactive engine 710.

In some implementations, the neural interactive engine 710 may be configured to enable supporting training of the neural networks (or other AI-based functions) used therein. For example, the neural interactive engine 710 may be configured to enable training the neurons of the neural network 740 of the neural interactive engine 710. For example, the neurons of the neural network 740 may be trained to generate or synthesize content for different game environments, different game entities, different attributes or features, etc. The training may be done using, e.g., suitable data, which may be obtained (e.g., uploaded) from databases.

As illustrated in FIG. 7, the neural interactive engine 710 may receive input data and interaction data, and may generate, based on processing of the input data and the interaction data (e.g., via the neural network 740) output data (e.g., content, and/or information pertaining to the content and/or to rendering thereof) that is provided to an output device. The input data may comprise information relating to objects—e.g., color related information, depth related information, space/position related information, etc. The input data may also comprise previous frame(s) and information associated therewith. The interaction data may comprise information relating to the interaction with game entities (or any other objects). An output device may comprise any suitable device or system that may be used in the rendering of the graphics (and other related information) associated therewith. Example output devices may comprise computer, VR headset, etc.

The neural interactive engine 710 may process the input data and the interaction data, such as via the neural network 740, to generate the output data for the output device(s). The processing may comprise rendering related information relating to the game environment (or portion thereof) and/or various game entities, including determining adjustments from frame to frame, including spatial changes, temporal changes, and/or changes in response to interactions with particular game entities. Such determining may comprise using and/or assessing internal state variables and/or external state variables for various game entities, to determine when particular states are transformed, and details relating to any such transformation. This may comprise determining, and accounting for, changes in such variables (and corresponding internal and/or external state(s)) in reaction to any interactions with the game entities. An example use case scenario is illustrated and described in more detail with respect to FIG. 8.

FIG. 8 illustrates a scenario utilizing an interactive neural engine. Shown in FIG. 8 is game environment 800 (or portion thereof), which may be generated and controlled using neural interactive engine implemented in accordance with the present disclosure, such as the neural interactive engine 710 of FIG. 7.

In particular, illustrated in FIG. 8 is an example use scenario when using such neural interactive engine, particularly illustrating the interactive side/component of the neural interactive engine and use thereof. In this regard, as described herein a game environment is defined or characterized in terms of game entities thereof (e.g., objects, characters in the game, etc.). In particular, as noted each game entity may have an internal state and an external state, each of which comprising one or more corresponding variables. In this regard, the internal state drives behavior(s) of the game entity, whereas the external state drives interaction(s) by the game entity. Each game entity may be characterized (e.g., defined) in terms of 5 dimensions: 1) position/location (3 dimensions) in 3-dimensional space (e.g., (x, y, z,) based position); 2) time (as 4th dimension) representing temporal changes in 3D state of different elements; and 3) interactions (as 5th dimension) representing interaction with the game entity (e.g., by user/player) which may cause changes to the game entity (e.g., position thereof). Additional dimensions (such as those for orientation) are implied, but, in practice, require additional dimensions (3 dimensions using Euler angles or comparable with quaternions in the case of orientation).

In the example case scenario shown in FIG. 8, the game entity may be a car, which may be interacted with and/or used by a user/player in the game. Nonetheless, while the example case scenario shown is with a car, a different example would be a character in a game. As noted above, the environment as a whole may represent a “global state.” The car has internal and observable state, as well as external state. The internal state may correspond to parameters, factors, or the like in the car that would affect the car and its operations, particularly in response to interactions therewith. For example, the car's fuel level may be part of its internal state—e.g., lack of fuel may cause the car to stop. The internal state may also include the car's geometry. In this regard, impact involving the car (e.g., another car hitting it, or the car hitting a stationary object) would alter its geometry, representing a reaction (to interaction).

As shown in FIG. 8, the location of the car may change with time in response to operation of the car. The position of the car may also be changed in response to interaction therewith—e.g., due to an interaction (e.g., by the user/player), the car is turned to the left and then may move to the left, with passage of time, whereas without the interaction, with the car facing to the right, the car proceeds to the right.

An example system for gaming, in accordance with the present disclosure, comprises a gaming platform that comprises a user device that comprises or is coupled to a display; and an interactive neural engine that comprises one or more circuits; where the interactive neural engine is configured to process, using artificial intelligence (AI), input data and interaction data; and generate, using the artificial intelligence (AI), based on the processing of the input data and the interaction data, output data for a game playable via the user device, for use during playing of the game via the user device; where the output data comprises data relating to one or both of rendering of a game environment associated with the game and/or one or more game entities associated with the game, and rendering of interactions with the game environment and/or the one or more game entities; and where the gaming platform being configured to display the output data via the display during the playing of the game via the user device.

In an example embodiment, the interactive neural engine is configured to characterize each of the one or more game entities using a combination of position/location based information, time based information, and interactions based information.

In an example embodiment, the interactive neural engine comprises a content component and an interaction component; where the content component is configured to provide content for the game; and where the interaction component is configured to handle interactions by and/or with the one or more game entities, and/or interactions within the game environment as a whole.

In an example embodiment, the content component is configured to provide the content of the game based on one or both of content generation and content synthesis.

In an example embodiment, the content component is configured to provide the content of the game based on combination of the content generation and the content synthesis across a continuum between a low limit for the content synthesis and a high limit for the content synthesis.

In an example embodiment, the low limit for the content synthesis is 0% and the high limit for the content synthesis is 100%.

In an example embodiment, the content component is configured to provide the content generation using computer generated (CG) graphics.

In an example embodiment, the content component is configured to provide the content synthesis using real content obtained via one or more capturing devices.

In an example embodiment, the interaction component is configured to handle the interactions using one or both an internal state and an external state associated with one or more of the one or more game entities.

In an example embodiment, the interactive neural engine is configured to use one or more neural networks for one or both of the processing of the input data and the interaction data, and the generating of the output data.

An example method for gaming, in accordance with the present disclosure, which may be performed in a gaming platform that comprises a user device that comprises or is coupled to a display, and an interactive neural game engine that comprises one or more circuits, may comprise processing, using artificial intelligence (AI), input data and interaction data; generating, using the artificial intelligence (AI), and based on the processing of the input data and the interaction data, output data for a game playable via the user device, for use during playing of the game via the user device; and displaying the output data via the display during the playing of the game via the user device; where the output data comprises data relating to one or both of rendering of a game environment associated with the game and/or one or more game entities associated with the game, and rendering of interactions with the game environment and/or the one or more game entities.

In an example embodiment, the method further comprises characterizing, using the artificial intelligence (AI), each of the one or more game entities using a combination of position/location based information, time based information, and interactions based information.

In an example embodiment, the method further comprises providing via a content component of the interactive neural engine, content for the game; and handling via an interaction component of the interactive neural engine, interactions by and/or with the one or more game entities, and/or interactions within the game environment as a whole.

In an example embodiment, the method further comprises providing via the content component the content of the game based on one or both of content generation and content synthesis.

In an example embodiment, the method further comprises providing via the content component the content of the game based on combination of the content generation and the content synthesis across a continuum between a low limit for the content synthesis and a high limit for the content synthesis.

In an example embodiment, the low limit for the content synthesis is 0% and the high limit for the content synthesis is 100%.

In an example embodiment, the method further comprises providing via the content component the content generation using computer generated (CG) graphics.

In an example embodiment, the method further comprises providing via the content component the content synthesis using real content obtained via one or more capturing devices.

In an example embodiment, the method further comprises handling via the interaction component the interactions using one or both an internal state and an external state associated with one or more of the one or more game entities.

In an example embodiment, the method further comprises using via the interactive neural engine one or more neural network for one or both of the processing of the input data and the interaction data, and the generating of the output data.

While the present invention has been described with reference to certain embodiments, it will be understood by those skilled in the art that various changes may be made and equivalents may be substituted without departing from the scope of the present invention. Further, while the present invention uses terminology with respect to gaming, this is not meant to limit the field of applications solely to entertainment. Descriptions contained herein apply to use cases where the utility of the invention can be realized. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for gaming, the system comprising:
a gaming platform that comprises:
a user device that comprises or is coupled to a display; and
an interactive neural engine that comprises one or more circuits;
wherein the interactive neural engine is configured to:
process, using artificial intelligence (AI), input data and interaction data; and
generate, using the artificial intelligence (AI), based on the processing of the input data and the interaction data, output data for a game playable via the user device, for use during playing of the game via the user device;
wherein the output data comprises data relating to one or both of:
rendering of a game environment associated with the game and/or one or more game entities associated with the game, and
rendering of interactions with the game environment and/or the one or more game entities; and
wherein the gaming platform is configured to display the output data via the display during the playing of the game via the user device.

2. The system according to claim 1, wherein the interactive neural engine is configured to characterize each of the one or more game entities using a combination of position/location based information, time based information, and interactions based information.

3. The system according to claim 1, wherein the interactive neural engine comprises a content component and an interaction component;
wherein content component is configured to provide content for the game; and
wherein the interaction component is configured to handle interactions by and/or with the one or more game entities, and/or interactions within the game environment as a whole.

4. The system according to claim 3, wherein the content component is configured to provide the content of the game based on one or both of content generation and content synthesis.

5. The system according to claim 4, wherein the content component is configured to provide the content of the game based on combination of the content generation and the content synthesis across a continuum between a low limit for the content synthesis and a high limit for the content synthesis.

6. The system according to claim 5, wherein the low limit for the content synthesis is 0% and the high limit for the content synthesis is 100%.

7. The system according to claim 4, wherein the content component is configured to provide the content generation using computer generated (CG) graphics.

8. The system according to claim 4, wherein the content component is configured to provide the content synthesis using real content obtained via one or more capturing devices.

9. The system according to claim 3, wherein the interaction component is configured to handle the interactions using one or both an internal state and an external state associated with one or more of the one or more game entities.

10. The system according to claim 1, wherein the interactive neural engine is configured to use one or more neural network for one or both of the processing of the input data and the interaction data, and the generating of the output data.

11. A method for gaming, the method comprising:
in a gaming platform that comprises a user device that comprises or is coupled to a display, and an interactive neural engine that comprises one or more circuits:
processing, using artificial intelligence (AI), input data and interaction data;
generating, using the artificial intelligence (AI), and based on the processing of the input data and the interaction data, output data for a game playable via the user device, for use during playing of the game via the user device; and
displaying the output data via the display during the playing of the game via the user device;
wherein the output data comprises data relating to one or both of:
rendering of a game environment associated with the game and/or one or more game entities associated with the game, and
rendering of interactions with the game environment and/or the one or more game entities.

12. The method according to claim 11, further comprising characterizing, using the artificial intelligence (AI), each of the one or more game entities using a combination of position/location based information, time based information, and interactions based information.

13. The method according to claim 11, further comprising;
providing via a content component of the interactive neural engine, content for the game; and
handling via an interaction component of the interactive neural engine, interactions by and/or with the one or more game entities, and/or interactions within the game environment as a whole.

14. The method according to claim 13, further comprising providing via the content component the content of the game based on one or both of content generation and content synthesis.

15. The method according to claim 14, further comprising providing via the content component the content of the game based on combination of the content generation and the content synthesis across a continuum between a low limit for the content synthesis and a high limit for the content synthesis.

16. The method according to claim 15, wherein the low limit for the content synthesis is 0% and the high limit for the content synthesis is 100%.

17. The method according to claim 14, further comprising providing via the content component the content generation using computer generated (CG) graphics.

18. The method according to claim 14, further comprising providing via the content component the content synthesis using real content obtained via one or more capturing devices.

19. The method according to claim 13, further comprising handling via the interaction component the interactions using one or both an internal state and an external state associated with one or more of the one or more game entities.

20. The method according to claim 11, further comprising using via the interactive neural engine one or more neural network for one or both of the processing of the input data and the interaction data, and the generating of the output data.
